(19) United States
(12) Patent Application Publication
(10) Pub. No.: US 2015/0227373 A1
(43) Pub. Date: Aug. 13, 2015

(54) STOP BITS AND PREDICATION FOR ENHANCED INSTRUCTION STREAM CONTROL

(71) Applicant: King Fahd University of Petroleum and Minerals, Dhahran (SA)

(72) Inventor: Muhamed Fawzi MUDAWAR, Dhahran (SA)

(73) Assignee: King Fahd University of Petroleum and Minerals, Dhahran (SA)

(21) Appl. No.: 14/175,604

(22) Filed: Feb. 7, 2014

(51) Int. Cl. G06F 9/38; G06F 9/30

(52) U.S. Cl. CPC G06F 9/3804; G06F 9/381; G06F 9/30145

(57) ABSTRACT

A microprocessor including an instruction set architecture includes: a decode and fetch control; a instruction cache; a data cache; a control stack; and an instruction set including a stop bit; a qualifying predicate; an opcode, a register and/or an immediate operand. A data processing method includes: fetch instructions encoded with a stop bit from an instruction set architecture of the microprocessor; popping, a top address off a control stack and transfer control back to a caller function, to an indirect function, or to a top of a loop block when the stop bit indicate a function return, an indirect function call, or a loop branch; save control stack registers on a backing store after the stop bit indicate the call or loop branch function when a number of used control stack registers exceeds a HI threshold; overflow a control stack signal when the number of the used and the saved entries exceeds the backing store size; allocate more memory to increase a size of the backing store from a data cache or terminate the execution; restoring, the control stack registers from the data cache when the number of the used control stack registers drops below a LO threshold.

### BACKGROUND

1. Field of the Disclosure

The exemplary embodiments described herein relate to an instruction set architecture, a microprocessor containing the instruction set architecture, and a computer processor or system using the instruction set architecture, for example in data processing systems.

2. Description of the Related Art

In data processing systems, control instructions alter the fetching and sequencing of instructions. Conditional branch (or jump) instructions are heavily used to control loops and if-else structures. They constitute about 17% of the dynamic instruction mix in many integer benchmarks. Procedure call and return instructions are about 3% of the dynamic instruction mix as described in Hennessy et al., (“Computer Architecture: A Quantitative Approach”, 5^{th} edition, Morgan Kaufmann publishers, 2012—incorporated herein by reference).

Conditional branch instructions are used heavily for instruction stream control. They appear at the end of loop blocks and branch backwards to control the execution of loops. They also appear inside if-else structures and branch forward to skip instruction blocks. Conditional branch instructions are used differently in different architecture as described in Intel, (“Intel 64 and IA-32 Architectures Software Developer's Manual, Volume 1: Basic Architecture, Volume 2A, 2B: Instruction Set Reference, Volume 3A, 3B: System Programming Guide”, November 2007—incorporated herein by reference), ARM, (“ARM Developer Suite”, Version 1.2, Assembler Guide, November 2001,—incorporated herein by reference), IBM, (“Power ISA”, Version 2.05, October 2007—incorporated herein by reference), Sun Microsystems, (“UltraSPARC Architecture, One Architecture Multiple Innovative Implementations”, Draft D0.9.3b, 20 Oct. 2009—incorporated herein by reference), MIPS Technologies, (“MIPS64 Architecture for Programmers, Vol 1: Introduction, Vol 2: MIPS64 Instruction Set, Vol 3: Privileged Resource Architecture”, Revision 3.02, Mar. 21, 2011—incorporated herein by reference) and Intel, (“Intel Itanium Architecture: Software Developer's Manual”, revision 2.3, May 2010—incorporated herein by reference). Many architectures, such as Intel x86 as described in Intel, (“Intel 64 and IA-32 Architectures Software Developer's Manual, Volume 1: Basic Architecture, Volume 2A, 2B: Instruction Set Reference, Volume 3A, 3B: System Programming Guide”, November 2007—incorporated herein by reference), ARM, (“ARM Developer Suite”, Version 1.2, Assembler Guide, November 2001,—incorporated herein by reference), IBM Power, (“Power ISA”, Version 2.05, October 2007—incorporated herein by reference), and Sun SPARC (“UltraSPARC Architecture, One Architecture Multiple Innovative Implementations”, Draft D0.9.3b, 20 Oct. 2009—incorporated herein by reference), use condition codes or flags (such as Zero, Negative, Carry, and Overflow) for conditional branching. Other architectures, such as MIPS (“MIPS64 Architecture for Programmers, Vol 1: Introduction, Vol 2: MIPS64 Instruction Set, Vol 3: Privileged Resource Architecture”, Revision 3.02, Mar. 21, 2011—incorporated herein by reference), use conditional compare and branch instructions for control, in which general-purpose registers are compared. Few others, such as Intel Itanium, (“Intel Itanium Architecture: Software Developer's Manual”, revision 2.3, May 2010—incorporated herein by reference), use predicate bits for conditional branching.

In addition, all architectures provide instructions for procedure call and return. The CALL instruction in the Intel x86 architecture pushes the return address in memory on the stack as described in Intel, (“Intel 64 and IA-32 Architectures Software Developer's Manual, Volume 1: Basic Architecture, Volume 2A, 2B: Instruction Set Reference, Volume 3A, 3B: System Programming Guide”, November 2007—incorporated herein by reference). On the other hand, the JAL instruction in the MIPS architecture saves the return address in the general-purpose register R31 as described in MIPS Technologies, (“MIPS64 Architecture for Programmers, Vol 1: Introduction, Vol 2: MIPS64 Instruction Set, Vol 3: Privileged Resource Architecture”, Revision 3.02, Mar. 21, 2011—incorporated herein by reference). The IBM Power (“Power ISA”, Version 2.05, October 2007—incorporated herein by reference) and Intel Itanium (“Intel Itanium Architecture: Software Developer's Manual”, revision 2.3, May 2010—incorporated herein by reference) architectures use a special-purpose link register to save the return address.

The return instruction has also different names in different instructions set architectures. For example, the Intel x86 architecture calls it RET as described in Intel, (“Intel 64 and IA-32 Architectures Software Developer's Manual, Volume 1: Basic Architecture, Volume 2A, 2B: Instruction Set Reference, Volume 3A, 3B: System Programming Guide”, November 2007—incorporated herein by reference). When executing this instruction, the processor pops the return address from the memory stack segment into the instruction pointer. The ARM uses the MOV instruction to copy the link register R14 into the program counter register R15 as described in ARM, (“ARM Developer Suite”, Version 1.2, Assembler Guide, November 2001,—incorporated herein by reference). The POWER architecture uses BCLR (Branch Conditional to Link Register) as a conditional return instruction, where the return address is stored in the link register LR as described in IBM, (“Power ISA”, Version 2.05, October 2007—incorporated herein by reference). The MIPS architecture uses JR (Jump Register) as the return instruction, where register R31 contains the return address as described in MIPS Technologies, (“MIPS64 Architecture for Programmers, Vol 1: Introduction, Vol 2: MIPS64 Instruction Set, Vol 3: Privileged Resource Architecture”, Revision 3.02, Mar. 21, 2011—incorporated herein by reference).

The conditional branch instruction, regardless of its name, has a high frequency that cannot be ignored. This instruction occupies space in the instruction cache, and consumes cycles and energy to execute. Branches decrease performance and consume hardware resources for dynamic branch prediction. They also restrict instruction scheduling by the compiler. This invention shows that conditional branch instructions can be eliminated in most situations. In addition, the return instruction can also be eliminated.

Some conditional branch instructions used in if-else structures can be eliminated with predication. Predication is not a new idea. It has been used in two prominent architectures: the ARM (“ARM Developer Suite”, Version 1.2, Assembler Guide, November 2001,—incorporated herein by reference), and the Intel Itanium architecture (“Intel Itanium Architecture: Software Developer's Manual”, revision 2.3, May 2010—incorporated herein by reference). Predication allows the tagging of all instructions with a qualifying predicate. If the value of the qualifying predicate is false at execution time, the predicated instruction behaves like a NOP. The ARM architecture uses condition codes (Zero, Negative, Carry, Overflow) to achieve conditional execution. On the other hand, the Itanium architecture uses qualifying predicate registers to achieve conditional execution. Predication helps in reducing the number of conditional branches, especially those used in nested if-else structures. However, it cannot eliminate backward conditional branches that appear at the end of loop structures.

Another drawback of instruction set architectures is that return addresses are saved on a stack segment in memory, especially for nested procedure calls. Because return addresses can be updated and manipulated like data, attackers can induce arbitrary behavior in a program by diverting the control flow, without injecting code. This technique, called return-oriented programming, was demonstrated in Buchanan et al., (“When Good Instructions Go Bad: Generalizing Return-Oriented Programming to RISC”, in Proceedings of the 15^{th} ACM conference on Computer and Communications Security,” CCS'08, pages 27-38, October 2008, Virginia, USA—incorporated herein by reference). The authors showed that return-oriented programming is not limited to the x86 ISA, but is widely applicable to many RISC architectures and operating systems (such as Linux and Solaris). Return-oriented programming defeats and bypasses the W⊕X protections, developed in operating systems, in which memory is either marked as writable or executable, but never both.

### SUMMARY

A microprocessor, including: a decode configured to decode instructions of an instruction set architecture; a fetch control unit configured to fetch instructions from a memory; an instruction cache configured to store a plurality of fixed byte-length instructions; a data cache configured to store data; a control stack implemented with high speed control registers and a backing store allocated memory by a system software, and configured as a side effect of control and the stop bits to isolate control stack entries and addresses from direct manipulation from a user program; and an instruction set, including: a stop bit configured to indicate a function return, an indirect function call, or a loop branch, and pop a top address off the control stack and transfer the control back to a caller function, to an indirect function, or to a top of a loop block; a qualifying predicate configured to allow a compare instruction to target an arbitrary number of predicates; and an opcode configured to specify an operation to be performed.

In one embodiment, the stop bit eliminates return instructions and conditional branch instructions at an end of a loop block.

In another embodiment, the qualifying predicate allows a compare instruction to target an arbitrary number of predicates and reduces the conditional branch instructions.

In another embodiment, the stop bit marked in a conditional compare and return instruction discards a boolean result and triggers a return operation when the qualifying predicate and the boolean result are both true.

In another embodiment, the control stack replaces return instructions with the stop bit when performing loop iterates, function returns and indirect function calls.

In another embodiment, the instruction set includes a register and an immediate operand.

In another embodiment, the instruction set includes a register.

In another embodiment, the instruction set includes an immediate operand.

In a second aspect the present disclosure includes a data processing method, including:

fetching, with processing circuitry, instructions encoded with a stop bit from an instruction set architecture of the microprocessor; popping, with processing circuitry, a top address off a control stack and transfer control back to a caller function, to an indirect function, or to a top of a loop block when the stop bit indicate a function return, an indirect function call, or a loop branch;
saving, with processing circuitry, control stack registers on a backing store after the stop bit indicate the function return, the indirect function call, or the loop branch when a number of used control stack registers exceeds a HI threshold; overflowing, with processing circuitry, a control stack signal when the number of the used and the saved entries exceeds the backing store size; allocating, with processing circuitry, more memory to increase a size of the backing store from a data cache or terminating the execution; restoring, with processing circuitry, the control stack registers from the data cache when the number of the used control stack registers drops below a LO threshold.

In one embodiment, the control stack implemented with high speed control registers and a backing store allocated memory by system software, and configured as a side effect of control and the stop bits to isolate control stack entries and addresses from direct manipulation from a user program.

In another embodiment, the stop bit eliminates return instructions and conditional branch instructions at an end of a loop block.

In another embodiment, the qualifying predicate allows a compare instruction to target an arbitrary number of predicates and reduces the conditional branch instructions.

In another embodiment, the stop bit marked in a conditional compare & return instruction discards a boolean result and triggers a return operation when the qualifying predicate and the boolean result are both true.

In a further aspect the present disclosure includes a non-transitory computer-readable medium storing executable instructions, which when executed by a computer processor, cause the computer processor to execute a method including: fetching, with processing circuitry, instructions encoded with a stop bit from an instruction set architecture of the microprocessor;

popping, with processing circuitry, a top address off a control stack and transfer control back to a caller function, to an indirect function, or to a top of a loop block when the stop bit indicate a function return, an indirect function call, or a loop branch; saving, with processing circuitry, control stack registers on a backing store after the stop bit indicate the function return, the indirect function call, or the loop branch when a number of used control stack registers exceeds a HI threshold; overflowing, with processing circuitry, a control stack signal when the number of the used and the saved entries exceeds the backing store size; allocating, with processing circuitry, more memory to increase a size of the backing store from a data cache or terminating the execution; restoring, with processing circuitry, the control stack registers from the data cache when the number of the used control stack registers drops below a LO threshold.

### BRIEF DESCRIPTION OF THE DRAWINGS

FIG. 1A depicts a block diagram of an instruction format for providing instructions in accordance with the present embodiment.

FIG. 1B depicts a block diagram of an instruction block terminated with a stop bit in accordance with the present embodiment.

FIG. 2A depicts Call/Return Sequence when the stop bit is used as a function return in accordance with the present embodiment.

FIG. 2B depicts a block diagram of a Call/Branch instruction format in accordance with the present embodiment.

FIG. 3A depicts Deferred Call/Return Sequence when the stop bits are used for function call and return in accordance with the present embodiment.

FIG. 3B depicts a DCALL Instruction Format in accordance with the present embodiment.

FIG. 4A depicts the stop bit used as a loop branch and a continuation signal in accordance with the present embodiment.

FIG. 4B depicts the stop bit used as a loop branch and a function return in accordance with the present embodiment.

FIG. 4C depicts an operation of Loop & Continue (LC) and Loop & Return (LR) entries on control stack with the present embodiment.

FIG. 4D depicts a DLOOP Instruction Format in accordance with the present embodiment.

FIG. 5A depicts a Skip& Continue that pops the top entry off the control stack and branches to a PC-relative in accordance with the present embodiment.

FIG. 5B depicts a Skip & Return marked with a stop bit stop bit that pops two entries off the control stack in accordance with the present embodiment.

FIG. 5C depicts a Skip Instruction Format in accordance with the present embodiment.

FIG. 6A depicts an R-type instruction format in accordance with the present embodiment.

FIG. 6B depicts an I-type instruction format in accordance with the present embodiment.

FIG. 7A depicts a control stack and a control stack backing store in accordance with the present embodiment.

FIG. 7B depicts a format of various code segment (CS) entries in accordance with the present embodiment.

FIG. 7C depicts a block diagram of a Control Stack Status Register (CSSR) in accordance with the present embodiment.

FIG. 8A depicts an example of a recursive call to function in accordance with the present embodiment.

FIG. 8B depicts recursive calls push A-entries on the control stack having identical return addresses in accordance with the present embodiment.

FIG. 8C depicts identical Address (A) entries merged into one Loop & Return (LR) entry in accordance with the present embodiment.

FIG. 8D depicts the returning from recursive calls reduces the Loop & Return (LR) counter when the stop bit is encountered in accordance with the present embodiment.

FIG. 9 depicts a block diagram of a control stack interface in accordance with the present embodiment.

FIG. 10A depicts a flow chart of a CALL instruction in accordance with the present embodiment.

FIG. 10B depicts a flow chart of a DCALL instruction in accordance with the present embodiment.

FIG. 10C depicts a flow chart of a DLOOP instruction in accordance with the present embodiment.

FIG. 10D depicts a flow chart of a save operation of Code Segment (CS) registers on the backing store when the number of Used CS registers exceeds a HI threshold in accordance with the present embodiment.

FIG. 10E depicts a flow chart of a processing of STOP bits for non-control instructions in accordance with the present embodiment.

FIG. 10F depicts a flow chart of a SKIP instruction in accordance with the present embodiment.

FIG. 10G depicts a flow chart of restore operations of Code Segment (CS) registers from the backing store when the number of Used CS registers drops below a LO threshold in accordance with the present embodiment.

FIG. 11A depicts targeting predicates in the PR register in accordance with the present embodiment.

FIG. 11B depicts an example of targeting a group of predicates in accordance with the present embodiment.

FIG. 11C depicts an example of using a group of predicates to translate a nested IF-ELSE structure in accordance with the present embodiment.

FIG. 12A depicts an encoding scheme of encoding 7-bit pattern t for targeting predicates as a 5-bit target ptf in an instruction format in accordance with the present embodiment.

FIG. 12B depicts a derivation of the logic equations for decoding the 5-bit target ptf into a 7-bit pattern t in accordance with the present embodiment.

FIG. 12C depicts logic equations for computing all the seven predicate bits in the PR register in accordance with the present embodiment.

FIG. 13 shows a schematic diagram of an exemplary processing system.

### DETAILED DESCRIPTION

The proposed embodiment uses a new instruction set architecture that features stop bits and predication. It associates a qualifying predicate and a stop bit with each instruction in the instruction set.

The stop bit is encoded as part of each instruction in the architecture. If the stop bit of an instruction is set, it marks the end of an instruction block. The stop bit can indicate a function return, an indirect function call, or a loop branch. It pops the top address off the control stack and transfers control back to the caller function, to the indirect function, or to the top of a loop block. The stop bit is just a single bit in the instruction format. However, it eliminates the need for many return instructions and conditional branch instructions that appear at the end of loop blocks.

Predication reduces the need for conditional branch instructions in if-else structures. The Intel Itanium architecture as described in Intel, (“Intel Itanium Architecture: Software Developer's Manual”, revision 2.3, May 2010—incorporated herein by reference) allows a compare instruction to compute one or at most two predicates. On the other hand, this invention allows a compare instruction to target an arbitrary number of predicates. This approach simplifies the translation of complex Boolean expressions and nested if-else structures.

Another feature of this embodiment is the control stack, which is implemented using high speed control registers. It has a backing store in memory, which can be defined only by the system software. The control stack registers save the return addresses of function calls, the indirect addresses of functions, the loop block addresses, and the loop counters. The control stack is not exposed to the programmer as architecturally visible registers. Instead, it is modified as a side effect of control instructions that push addresses and counters on the control stack, and stop bits that pop this data. The control stack is isolated from direct manipulation by the user program. This prevents its exploitation and also improves the security of the architecture.

It should be noted that some instruction fetch units have proposed a return-address stack unit for the fast execution of call and return instructions as described in Henry et al., (“Microprocessor with Fast Execution of Call and Return Instructions”, U.S. Pat. No. 8,423,751 B2, Apr. 16, 2013—incorporated herein by reference). However, this invention features a control stack which is more general than a return-address stack unit. First, there is no return instruction. A stop bit can be used to achieve a function return. Second, the same control stack can be used to control loop iterates, to achieve indirect function calls, in addition to function returns. The stop bit is used to pop the target loop block address, the indirect function address, and the return address, without the need for an extra and more costly branch address predictor.

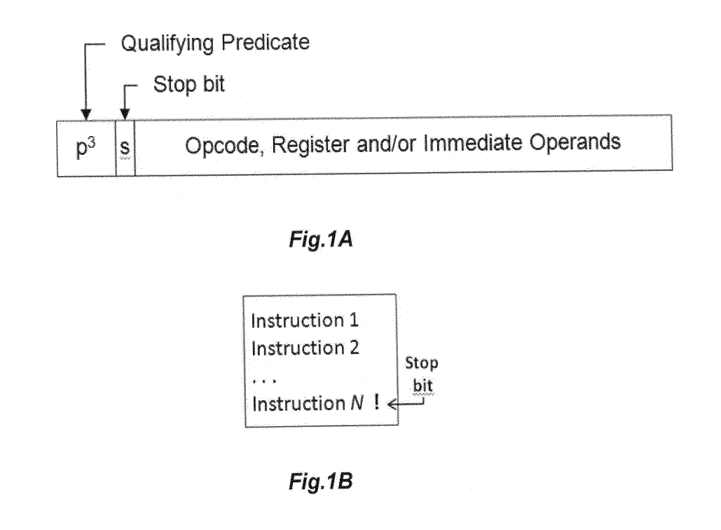

FIG. 1A shows a fixed-size 32-bit format for all instructions. The qualifying predicate (p) occupies the upper 3 bits of the instruction format. The stop bit appears next. The remaining 28 bits are used for the opcode, register and/or immediate operands. The qualifying predicate is used for conditional execution. The stop bit is used for conditional return, for indirect function call, and for conditional loop branching.

A program is divided into instruction blocks. An instruction block is defined as a sequence of instructions that terminates with a stop bit, as shown in FIG. 1b. The ‘!’ symbol denotes a stop bit in the assembly syntax. The instruction block can be the target of a control instruction (such as CALL) that initiates its execution. The last instruction is marked with a stop bit. Any number of control instructions may appear inside an instruction block that transfer control to other instruction blocks.

The stop bit of a non-control instruction is equivalent to a function return, an indirect function call, or a loop branch. The instruction fetch unit pops the top address off the control stack to transfer control back to the target instruction block. Program or thread termination is detected when there is no return address to pop off the control stack.

Eight single-bit qualifying predicates are defined, namely p0 thru p7. Predicate p0 is always true, and cannot be written. It is used for the unconditional execution of instructions. If the qualifying predicate of an instruction is not specified, it defaults to (p0).

Predicates p1 to p7 can be written. They control the execution of instructions. If the qualifying predicate (p) of an instruction is false then the instruction need not issue for execution. It can be dropped from the execution pipeline. Alternatively, if a predicated ALU instruction has been issued early for execution and its qualifying predicate (p) is computed later as false, then the result is discarded. The destination register is not updated.

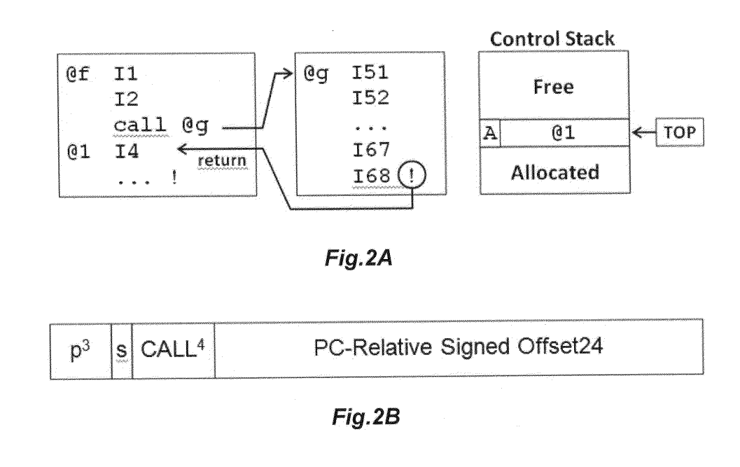

The CALL instruction invokes a function. It transfers control to a target instruction block. The CALL instruction format is shown in FIG. 2B. The opcode field is only 4 bits. The address of the target instruction block is encoded as a 24-bit PC-relative signed offset in the instruction format. The CALL instruction computes the target instruction address as: PC=PC+Offset24.

An example of function call and return is shown in FIG. 2A, where function f calls g. The CALL instruction pushes the return address on the control stack. The A-entry on the control stack is an address entry that saves the return address of a function call. The last instruction I68 in function g is marked with a stop bit (! symbol). The stop bit pops the return address off the control stack and transfers control back to the caller function. The stop bit eliminates the need for a return instruction.

The CALL instruction is predicated, and executes a target instruction block conditionally. If the qualifying predicate (p) has a false value, the predicated CALL instruction has no effect, as if the instruction did not exist. If the qualifying predicate (p) is not specified, it defaults to (p0), which is always true and used for unconditional execution.

The CALL instruction has two meanings depending on its stop bit. If the stop bit of a CALL instruction is clear, it is an ordinary procedure CALL with a return address. The return address is pushed on the control stack as shown in FIG. 2A. On the other hand, if the stop bit of a CALL instruction is set, there is no return address and the control stack is not updated. This is equivalent to a conditional branch, which is defined as a pseudo-instruction:

(p) BR @target//Pseudo: (p) CALL @target!

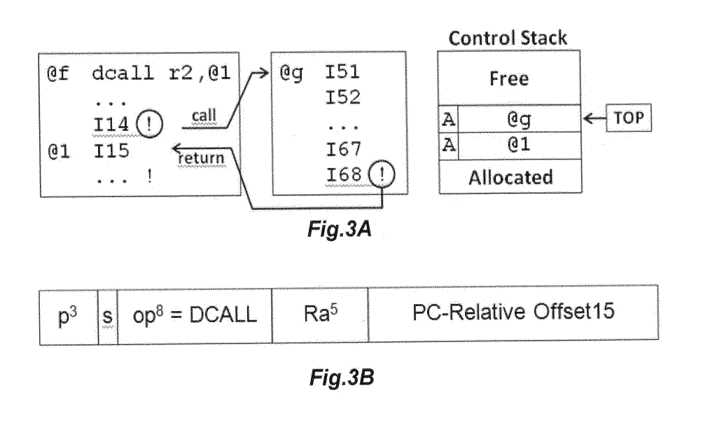

Function calls can be deferred and stop bits can initiate indirect function calls, in addition to function returns. The DCALL instruction, shown in FIG. 3, defines a function call. It pushes two addresses (A-type entries) on the control stack. The first address is a register indirect function address (value of Reg[Ra]). The second address is a PC-relative return address. The register indirect function address is pushed on top of the PC-relative return address, such that the indirect function call occurs first. The DCALL instruction has the following syntax:

(p) DCALL Ra, @target {!}//if (p) push two A entries on the CS

The indirect function call does not happen immediately. It is deferred until a later instruction. For example, instruction I14 marked with a stop bit in FIG. 3A, invokes indirectly function g. It pops the register indirect function address @g off the control stack. On the other hand, instruction I68, which is the last instruction in function g, pops the return address @1 and transfers control back to function f at the return address.

The DCALL instruction can also be marked with a stop bit. If the stop bit of a DCALL instruction is set, then the indirect function call occurs immediately. Only one A-entry, carrying the PC-relative return address, is pushed on the control stack.

The importance of the DCALL instruction is that it can be scheduled early by the compiler. This can provide sufficient time for the fetch unit to push addresses (especially the register indirect function address) on the control stack, before the actual indirect function call (or stop bit) appears in the instruction stream. Therefore, the indirect function call can be deferred, which reduces the stalling of the instruction fetch unit and improves its performance.

The DCALL instruction format is shown in FIG. 3B. Source register Ra specifies the indirect function address, while the 15-bit PC-relative offset specifies the return address. The DCALL instruction computes the return address as: PC=PC+Offset15.

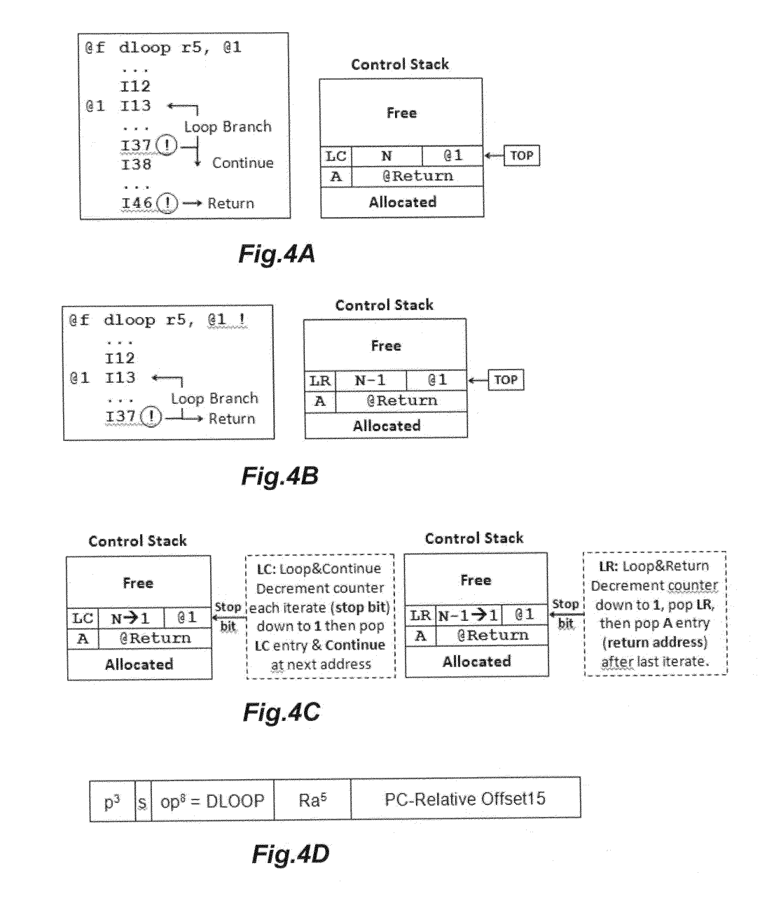

In addition to function return and indirect function call, the stop bit can also achieve a loop branch without the use of a branch instruction. Loops can be defined early in the instruction stream. The DLOOP instruction, shown in FIG. 4, defines a counter-controlled loop. Source register Ra specifies the loop counter and a PC-relative offset specifies the loop block address. The DLOOP instruction format is shown in FIG. 4D. It has the following syntax:

(p) DLOOP Ra, @target {!}//if (p) push a loop entry on the CS

Depending on the stop bit, the DLOOP instruction defines two types of loops. If the stop bit of a DLOOP instruction is clear, it is called Loop& Continue. The DLOOP instruction pushes the LC entry on the control stack, as illustrated in FIG. 4A. The LC entry stores the counter value N of source register Ra and the loop block address. The stop bit of instruction I37 is used as a loop branch. It decrements the counter value of the LC entry and branches to address @1 of instruction I13. The LC counter is decremented down to 1 on the control stack to achieve N iterates, as shown in FIG. 4C. Then, the stop bit of I37 pops the LC entry (with counter=1) and continues at the next address after completing the last iterate. The stop bit is used as a continuation signal to exit the loop.

On the other hand, if a DLOOP instruction is marked with a stop bit then it is called Loop & Return. The DLOOP instruction pushes the LR entry on the control stack, as illustrated in FIG. 4B. The LR entry stores the decremented value (N−1) of source register Ra and the loop block address on the control stack. Unlike the LC entry, the LR entry decrements the counter value before pushing it on the control stack. The counter value N cannot be 1, or else no LR entry is pushed on the control stack. Similar to LC, the stop bit decrements the counter value of the LR entry from (N−1) down to 1 on the control stack, as shown in FIG. 4C. However, there is no continuation signal. The LR entry is popped after completing (N−1) iterates. Then, the A-entry is popped after completing the last iterate, hence achieving a function return. Therefore, the same stop bit of instruction I37 is used as a loop branch and a function return.

Loop blocks can be nested. Multiple LC/LR entries may appear on the control stack, each having its loop address and counter. The stop bit eliminates many loop branches, resulting in simpler and faster instruction flow control. The DLOOP instruction does not accept a zero counter. If the value of counter register Ra is zero then no LC/LR entry is pushed on the control stack. The programmer can avoid this situation by checking and bypassing the loop block when the counter is zero.

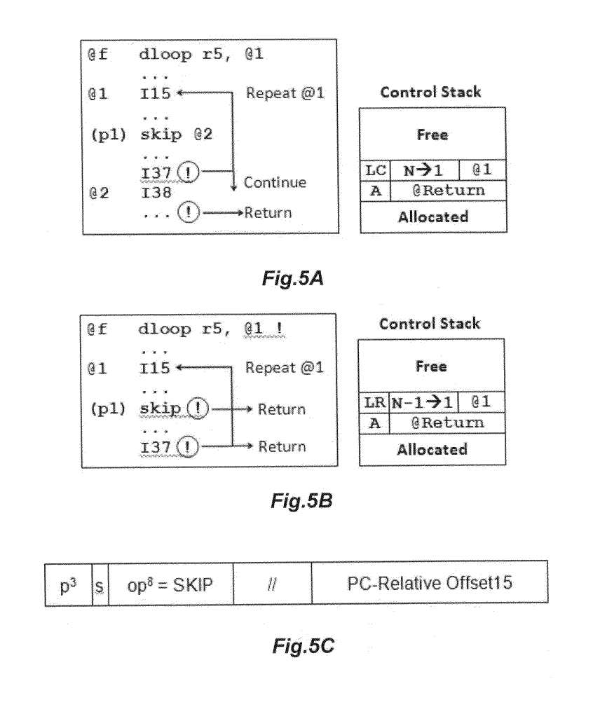

The SKIP instruction can be used to terminate a counter-controlled loop prematurely. It pops the top entry off the control stack, regardless of its type. There are two variations of the SKIP instruction: Skip & Continue (stop bit is clear) and Skip & Return (stop bit is set). The SKIP instruction format is shown in FIG. 5C. The PC-relative offset specifies the continuation address for Skip & Continue. However, it has no use for Skip &Return, which is marked with a stop bit. The SKIP instruction has the following syntax:

| | |
|---|---|
| (p) SKIP @target | // if (p) pop top entry & continue @target |
| (p) SKIP ! | // if (p) pop top entry and return address |

An example of Skip & Continue is shown in FIG. 5A. If the qualifying predicate p1 of the skip @2 instruction is true, the LC entry that appears on top of the control stack is popped and instruction fetching continues at address @2.

An example of Skip & Return is shown in FIG. 5B. If the qualifying predicate p1 of skip! is true, the LR entry that appears on top of the control stack is popped. In addition, the stop bit pops the next A-entry off the control stack and instruction fetching continues at the return address. The exact behavior of the stop bit depends on the second top entry type on the control stack. For instance, if two LR entries appear on top of the control stack, then the Skip & Return instruction pops the top LR entry. However, the stop bit decrements the counter of the second LR entry. The stop bit is used to branch to the outer loop (second LR entry address).

The SKIP instruction can be generalized to pop multiple entries off the control stack. This is useful when escaping multiple nested loop blocks or returning from multiple nested function calls.

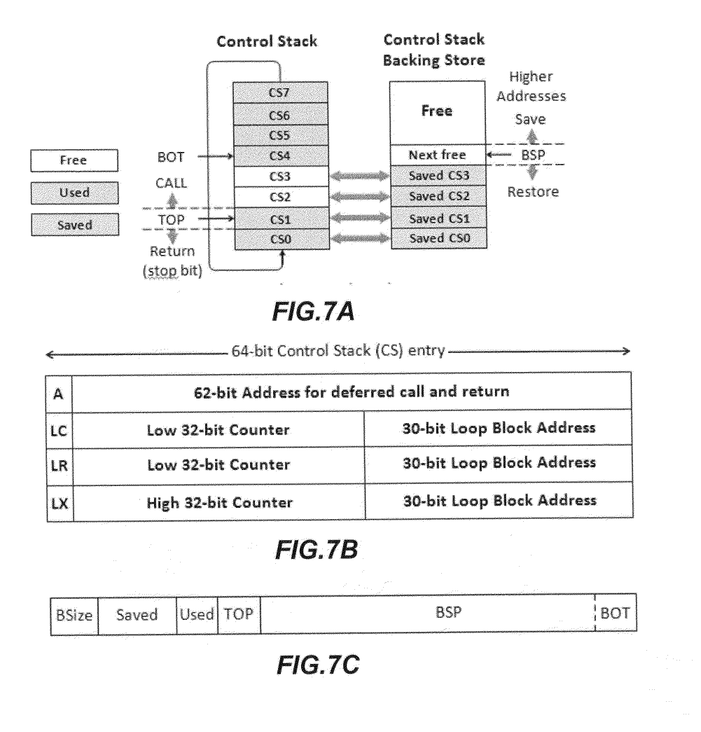

The control stack is a circular buffer implemented using 64-bit CS Registers. FIG. 7A shows a control stack with eight CS registers (CS0 to CS7). The control stack registers are not visible to the programmer. They are modified as a side effect of control instructions and stop bits. The number of CS registers allocated to one application (or thread) is implementation specific, but is always a power of two (such as 8 or 16).

A control stack has a corresponding backing store in memory, as illustrated in FIG. 7A. The system software allocates memory for the backing store. The backing store has a size, which indicates the maximum number of LR entries that can be saved in memory. Control stack overflow occurs when the control stack backing store is full. Control stack underflow occurs when the control stack is empty and there is no CS entry to pop. This indicates program or thread termination.

The CS entry is 64-bit long. The upper 2-bit of a CS entry specifies the entry type (or operation) on the control stack. Four CS entry types are defined in FIG. 7B: A, LC, LR, and LX. The A-entry stores a 62-bit address for a deferred function or a return address. The 62-bit instruction address is appended with two implicit zeros to obtain a 64-bit byte address, because instructions are 4-byte long and aligned in memory. The LC (or LR) entry is defined by a DLOOP instruction, whose stop bit is clear (or set). The loop block address field is only 30-bit long, which is large enough for loop blocks. The upper address bits of the loop block are unchanged in the program counter. The implication is that a loop block should not cross the boundary of a 4-GByte memory segment (or 2³⁰ instructions). The loop counter field is only 32-bit long, which is sufficiently large for most situations.

The LX entry can be paired with the LC or LR entry to define a loop with a 64-bit counter. The DLOOP instruction pushes two entries on the control stack if the counter value is larger than 32 bits. The LX entry is removed when the counter value drops below 2³².

The control stack is not exposed to the programmer as architecturally visible registers. Instead, it is modified as a side effect of CALL, DCALL, DLOOP, SKIP, and STOP bits. This isolates the CS entries and addresses from direct manipulation and prevents their exploitation. The control stack operation is managed by hardware. Its internal state is saved in the control stack status register CSSR, shown in FIG. 7C. The following fields define the internal state of the control stack in Table I:

TABLE I

| Field Name | Description |
|---|---|
| BSize | Backing Store Size: maximum number of CS entries that |
| | can be saved |
| Saved | Number of CS entries that are currently saved on the |
| | backing store |
| Used | Number of CS registers that are currently used on the |
| | control stack |
| TOP | Top CS register number on the control stack |
| BOT | Bottom CS register number on the control stack |
| BSP | Backing Store Pointer: Address of next free entry on the |
| | backing store |

The BSize field specifies the maximum number of CS entries that can be saved on the backing store. The BSize is defined as multiple of the physical number of CS registers on the control stack. If there are only 8 CS registers (as shown in FIG. 7A) then the lower 3 bits of BSize are implicitly zeros. For instance, if BSize field is 4 then at most 4×8=32 entries can be saved in memory. The system software allocates a page (or more) in memory for the backing store. This allocation can be done once when initializing the control stack, or on demand when the control stacks overflows.

The Saved field specifies the number of CS entries that are currently saved on the backing store. Any number of CS entries can be saved as long as this number does not exceed the BSize limit.

The Used field specifies the number of physical CS registers that are currently used on the control stack. If there are only 8 CS registers then 0≦Used≦7. At least one CS register is kept free. To ensure that all Used CS entries can be saved in memory, then Saved+Used≦BSize.

The TOP field points to the top CS register on the control stack. When a new entry is pushed on the control stack, the TOP field is incremented and then the new TOP CS register is written. The BOT field points to the bottom CS register on the control stack. The control stack saves and restores CS registers at the bottom of the control stack, using the BOT field.

The BSP pointer is the address of the next free entry on the backing store. Since the backing store entries are aligned in memory on 8-byte boundary, the lower 3 bits of the byte address are always zeros (implied but not stored in BSP). In addition, the BOT field is mapped to the lower address bits of the BSP pointer, as shown in FIG. 7C. The BOT field changes according to the BSP pointer, when CS entries are saved and restored.

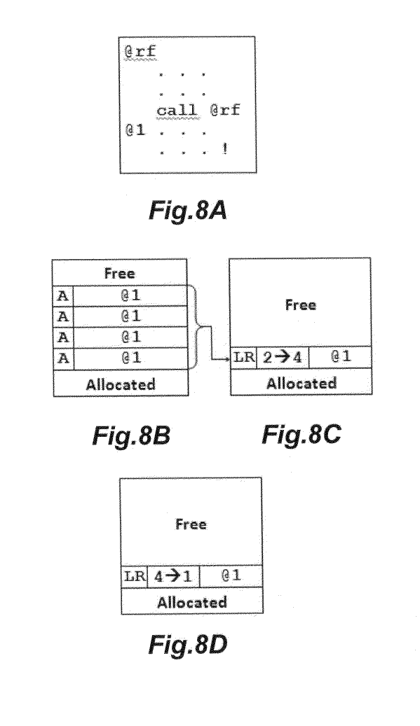

Deep recursive calls can push many A-entries and overflow the control stack. FIG. 8a shows an example recursive function rf with a direct recursive call. The call @ rf instruction can push many A-entries with identical @1 return addresses, as shown in FIG. 8B.

A simple optimization is to merge identical A-entries on the control stack, by introducing the LR entry, as shown in FIG. 8C. The A-entry with return address @1 is converted into an LR entry with counter equal to 2, when the second recursive call pushes an A-entry with identical return address @1. Then, each recursive call compares the return address against the LR address on top of the control stack. The LR counter is incremented as long as the return address matches the LR-entry address. For example, the LR counter is incremented from 2 to 4 in FIG. 8C, indicating four recursive calls with identical return address @1. When returning from recursive calls, the LR counter is decremented on each return as shown in FIG. 8D. The LR counter is reduced down to one, and then the LR entry is popped. This simple optimization works for direct recursive calls and reduces the number of CS entries on the control stack.

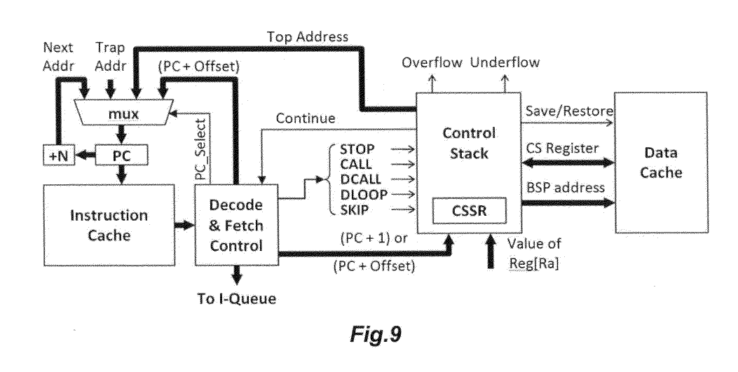

The control stack is implemented in the instruction fetch unit. It processes STOP bits of non-control instructions, as well as CALL, DCALL, DLOOP, and SKIP instructions (with and without STOP bits). FIG. 9 shows the control stack interface. An instruction block, consisting of at most N instructions, is fetched from the instruction cache. Then, it is decoded inside the Decode logic that directs STOP bits and control instructions for processing by the control stack, while non-control instructions are sent to the I-Queue for processing by the pipeline backend execution units (not shown). In addition, the Fetch Control logic outputs the PC Select signal for selecting the next PC value. Instruction fetching proceeds at the next instruction block address in memory if there are no control instructions or stop bits in the current instruction block, at the top address specified by the control stack if a stop bit is encountered, at (PC+Offset) if a CALL instruction or a SKIP with a continuation address is encountered, or at a trap address if an exception is encountered.

The control stack receives as input control signals (STOP, CALL, DCALL, DLOOP, and SKIP) from the decode logic. It also receives as input (PC+4) which can be the return address of a CALL instruction, or (PC+Offset) which can be the return address of a DCALL instruction or the loop block address of a DLOOP instruction. In addition, it receives as input the value of register Ra, which can be the indirect function address of a DCALL instruction or the loop counter for a DLOOP instruction. The control stack outputs the Top Address of its top CS register, which can be the return address of a CALL or DCALL instruction, the indirect function address of a DCALL instruction, or the loop block address of a DLOOP instruction. It also outputs the Continue signal, which is asserted only if the top entry is LC with a counter value equal to 1. Finally, it outputs Overflow and Underflow exception signals when pushing an entry on a full control stack, or popping an entry off an empty control stack.

The fetch control logic selects the Top Address, when a STOP bit of a non-control instruction is encountered. However, it selects the Next Address (instead of the Top address), when the Continue signal is asserted in the presence of a STOP bit.

The control stack also interfaces with the Data Cache to save and restore CS registers on the backing store. The save operation writes one or more CS registers, which are at the bottom of the control stack, in the data cache. The BSP specifies the memory address. The BSP pointer is post-incremented after saving a CS register. The restore operation reads one or more CS registers from the data cache. The BSP pointer is pre-decremented before restoring a CS register.

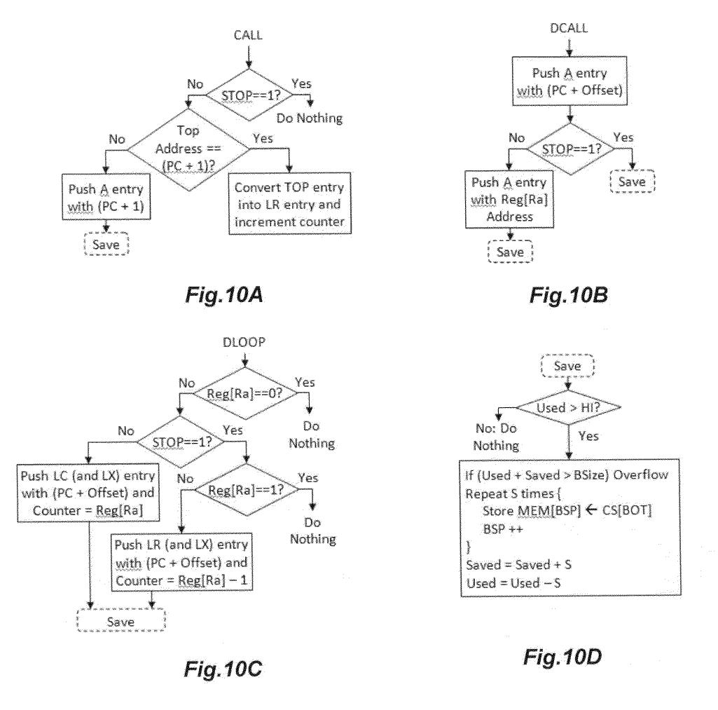

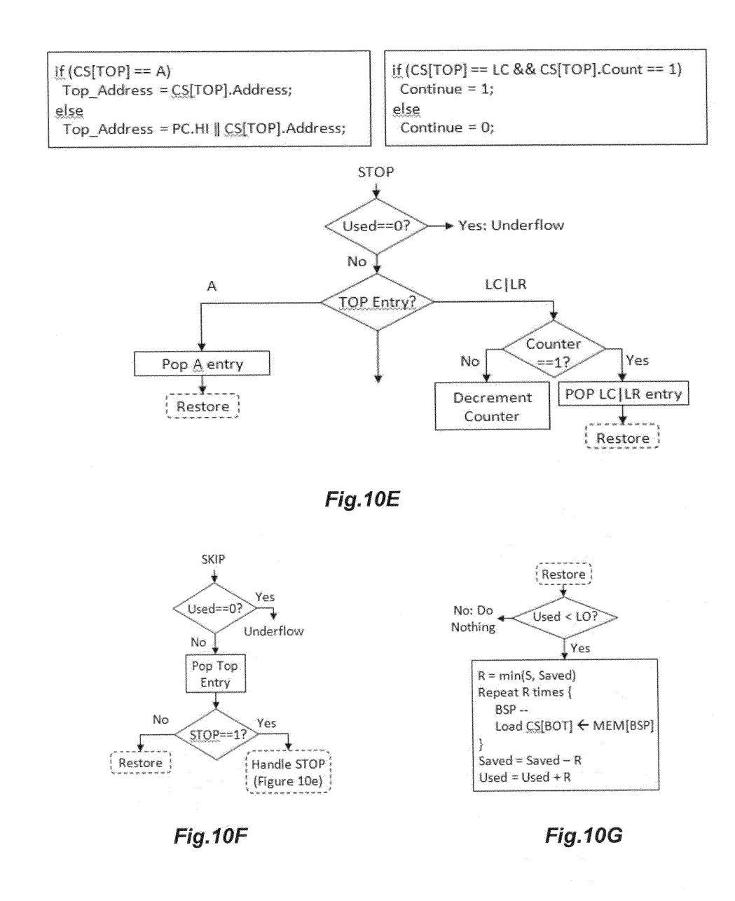

The control stack processes CALL, DCALL, DLOOP, and SKIP instructions with and without STOP bits. In addition, it processes STOP bits of non-control instructions. This processing is described in the flow charts of FIG. 10A thru 10G.

FIG. 10A describes the processing of the CALL instruction. This instruction pushes an A-entry with return address (PC+1) on the control stack, if the STOP bit is clear. Otherwise no entry is pushed. It can also convert the top A-entry into an LR-entry with counter equal to 2, if the top A-entry address matches the return address (PC+1) of the CALL instruction. In addition, it increments the counter of the top LR-entry till it matches the return address (PC+1) of the CALL instruction. This optimization works for recursive functions, as illustrated in FIG. 8C.

FIG. 10B describes the processing of the DCALL instruction. This instruction pushes one or two entries on the control stack. First, the DCALL instruction pushes an A-entry with return address (PC+Offset). Then, it pushes a second A-entry for the indirect function address, which is the value of Register Ra. The second A-entry is pushed on top of the control stack if the STOP bit is clear. Otherwise, only one A-entry carrying the return address is pushed.

FIG. 10C describes the processing of the DLOOP instruction. Depending on the STOP bit, this instruction pushes either an LC or LR entry on the control stack, which stores the loop counter and the loop block address (PC+Offset). The loop counter is initialized to Reg[Ra] for an LC entry. However, it is initialized to (Reg[Ra]−1) for an LR entry marked with a STOP bit. If the counter register Ra is zero then no LC or LR entry is pushed on the control stack. In addition, if the counter register Ra is one then no LR entry is pushed. The LC or LR entry can only store a 32-bit counter value, as shown in FIG. 7B. If the counter value is larger than 32 bits then a second LX entry is also pushed on the control stack, for the upper 32 bits. Otherwise, no LX entry is required. The LX entry can be removed dynamically when the counter value drops below 2³² at runtime.

FIG. 10D describes the saving of CS registers on the backing store. The Save operation is triggered after a CALL, DCALL, or DLOOP operation, if the number of Used CS registers exceeds a HI threshold. Then, S registers are saved in the data cache. The constants HI and S are implementation specific. The control stack interfaces with the Data Cache for saving CS registers. If the number of (Used+Saved) entries exceeds the backing store size (BSize) then the control stack signals Overflow. The system software should either terminate the execution of the program, or allocated more memory to increase the BSize. Recall that the BSize, Saved, Used, and BSP are fields in the control stack status register as shown in FIG. 7C. The backing store is aligned in memory and the bottom CS register number (BOT) is mapped to the lower address bits of BSP. To save a CS register, the control stack stores the bottom register, CS [BOT], at BSP which points to the next free entry on the backing store. The BSP pointer is then incremented, which also increments the BOT register number.

FIG. 10E describes the processing of the STOP bit for a non-control instruction. The control stack always outputs the Top Address of the TOP CS entry. This can be a return address, a register indirect function address, or a loop block address. The A-entry contains a 62-bit instruction address, which is the Top Address. However, the LC (or LR) entry contains a 30-bit loop block address, which is concatenated with the upper 32-bit of the PC register to form the 62-bit Top Address. The lower 2 bits of the PC register are always zero (implicit but not stored) because all instructions are 4-byte long and aligned in memory. The control stack also outputs the Continue signal, which is 1 when the top entry is LC and the LC counter is equal to 1.

If the STOP bit of a non-control instruction is encountered and the control stack is empty then the control stack signals Underflow, which terminates the execution of the program (or running thread) and frees its resources. If there is no Underflow, the control stack pops the top entry if it is an A-entry. It also pops the top LC or LR entry if its counter is equal to 1. However, if the top LC or LR entry has a Counter>1 then the Counter is decremented only on the control stack.

FIG. 10F describes the processing of the SKIP instruction. As long as there is no underflow, this instruction always pops the TOP CS entry off the control stack, regardless of its type. If the SKIP instruction is marked with a STOP bit then the STOP bit is also processed according to FIG. 10E, and can pop a second entry.

FIG. 10G describes the restoring of CS registers from the Data Cache. The Restore operation is triggered after processing a STOP bit or a SKIP instruction, when the number of Used CS registers drops below a LO threshold. To restore, R registers are loaded from the data cache into the control stack registers. The BSP pointer is decremented (which also decrements the BOT register number), and then used to load the bottom CS register CS [BOT]. The LO threshold that triggers the restore operation and the number R of restored registers can vary according to implementation.

Compare instructions compute Boolean results and write these results into predicates. Each predicate stores a single-bit value (0 or 1). There are eight predicates, named p0 to p7. Predicate p0 is hardwired to true (always 1). It is used as the qualifying predicate of non-conditional instructions. The predicate bits are stored in a special-purpose register, called the PR register.

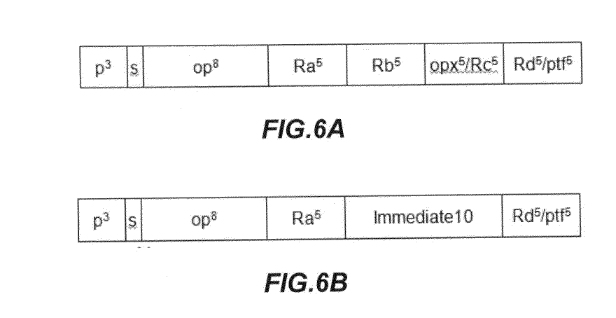

FIGS. 6A and 6B show the R-type and I-type formats of the majority of non-control instructions, including compare instructions. The target of an arithmetic instruction is denoted as Rd. However, the target of a compare instruction is denoted as pt or ptf.

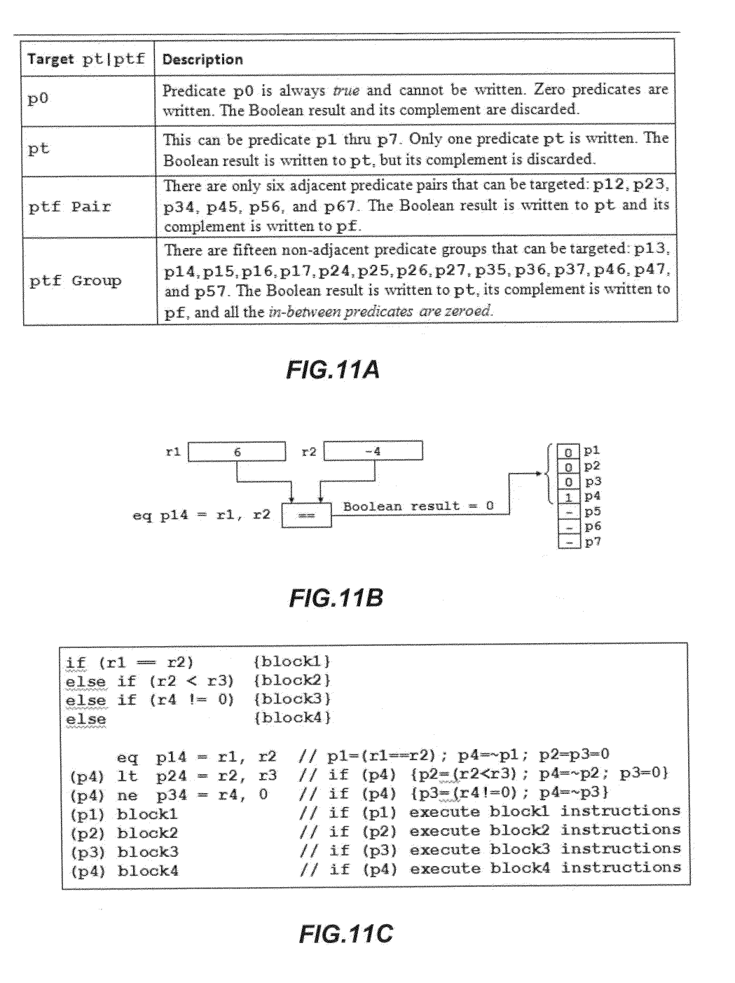

FIG. 11A describes the targeting of predicates in the PR register. Any number of predicates can be targeted by a compare instruction. If the target is p0 then no predicate is written. If the target is pt (p1 thru p7) then one predicate is written. In general, if the target is ptf then the Boolean result is written to pt, its complement is written to pf, and all the in-between predicates are zeroed. For example, if the target is p17 then all predicates are written. The Boolean result is written in p1, its complement is written in p7, and the in-between predicates (p2 thru p6) are zeroed.

FIG. 11B shows an example eq (equal) compare instruction that targets a group of predicates p1 thru p4, abbreviated as p14. The Boolean result is written to p1, its complement is written to p4, and all the in-between predicates p2 and p3 are zeroed. Targeting a group of predicates is unique to this invention. It is different from the approach used in the Intel Itanium architecture, in which at most two predicates can be targeted as described in Intel, (“Intel Itanium Architecture: Software Developer's Manual”, revision 2.3, May 2010—incorporated herein by reference). Targeting a group of predicates is useful when translating complex Boolean expressions and nested IF-ELSE structures.

FIG. 11C shows the translation of a nested IF-ELSE structure. Four predicates p1 thru p4 are associated with block1 thru block4, respectively in the nested IF-ELSE structure. The first eq instruction compute p14 as either 1000₂ or 0001₂. If p14=1000₂ then the following lt and ne instructions are skipped, block1 instructions are executed, while the other blocks are skipped.

On the other hand, if eq computes p14=0001₂, the next predicated lt instruction computes p24=100₂ or p24=001₂. If lt computes p24=100₂ then the next predicated ne instruction is skipped, block2 instructions are executed only, and the other blocks are skipped. However, if p24=001₂ then the next predicated ne instruction computes p34=10₂ or p34=01₂. This instruction decides whether block3 or block4 should be executed. The nested IF-ELSE structure guarantees that exactly one predicate (p1, p2, p3, or p4) is true, and that exactly one block is executed. This example shows that targeting multiple predicates works well with nested IF-ELSE statements. It eliminates the need for conditional branch instructions and simplifies instruction flow control.

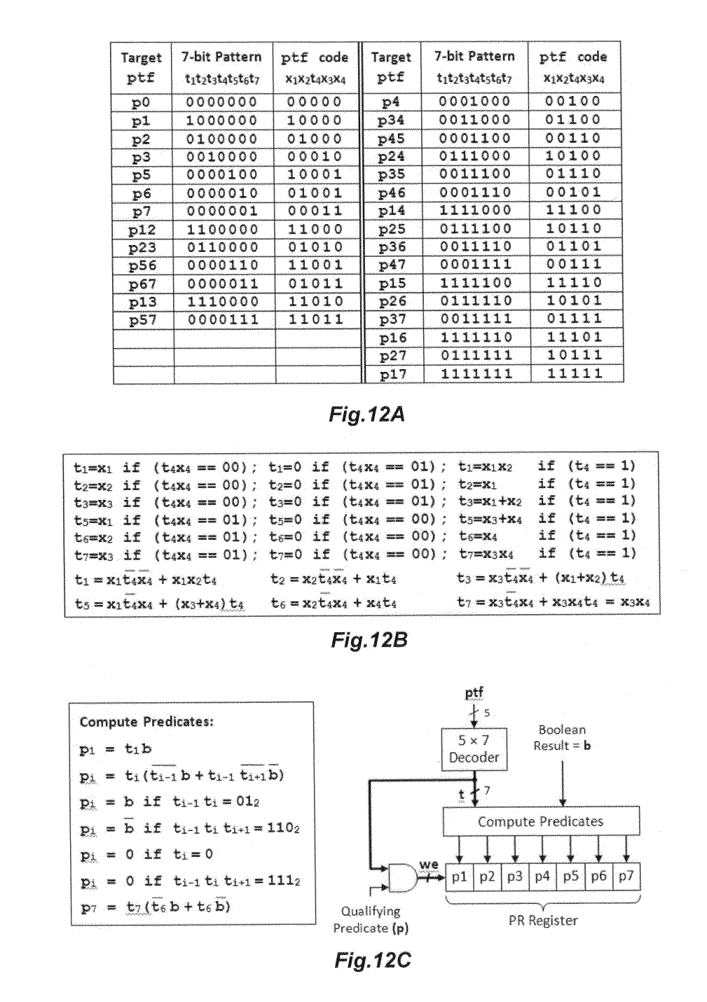

The target pt or ptf is represented by a 7-bit access pattern t, as shown in FIG. 12A. If the target is p0 then no predicate is written. On the other hand, if the target is p17 then all predicates are written. The 7-bit pattern t is encoded as a 5-bit target ptf in the instruction format. The 5-bit encoding scheme of the target ptf also appears in FIG. 12A. The 7-bit patterns are split into two groups according to the middle bit t₄. The group on the left have t₄=0 and the group on the right have t₄=1. Bit t₄ also appears as the middle bit in the 5-bit encoding of ptf. It is chosen this way to simplify the decoding logic.

The 5-bit coding of ptf is chosen to simplify the implementation of the 5×7 decoder of FIG. 12C. The ptf code consists of 5 bits: x₁x₂t₄x₃x₄. The middle bit t₄ is identical in the 7-bit pattern t and in the 5-bit code. The 5×7 decoder outputs t₁t₂t₃ and t₅t₆t₇. FIG. 12B shows the derivation of the logic equations for the 5×7 decoder that decodes the 5-bit target ptf into a 7-bit pattern t.

FIG. 12C shows the logic diagram for decoding, computing, and writing predicates. The ptf target is encoded as a 5-bit field in the instruction format. It is decoded using the 5×7 decoder. The 7-bit output pattern t of the decoder specifies the predicates that should be written. Seven predicates p1 thru p7 are computed, according to the 7-bit output pattern t and the Boolean result b. Predicate pᵢ is equal to b if tᵢ₋₁tᵢ=01. It is equal to b if b̅ᵢ₋₁tᵢtᵢ₊₁=110. Otherwise, it is 0.

The 7-bit write-enable (we) signal enables the writing of predicates in the PR register, under the control of the qualifying predicate (p). If (p) is false then all the seven we bits will be zeros and the PR register will be disabled. Otherwise, the we signal is identical to the 7-bit pattern t. The value of the qualifying predicate (p) is read from the PR register, except (p0), which is hardwired to 1.

If a compare instruction targets p0 and is marked with a stop bit (! symbol) then it is called Conditional Compare & Return. The compare instruction computes a Boolean result b as usual. However, the Boolean result is discarded because the target is p0. The stop bit of the compare instruction becomes effective and triggers a return operation (pops the return address off the control stack), if the qualifying predicate p and the Boolean result b are both true. Otherwise, the stop bit of the compare instruction has no effect.

Two examples of Conditional Compare & Return that target p0 and are marked with stop bits are shown below. If a compare instruction does not specify a target then the target is p0 by default. No predicate is updated. The first eq instruction computes a Boolean result b. If the Boolean result is true, then the stop bit becomes effective and control is transferred at the return address on top of the control stack. The second gt instruction is predicated with (p2). The stop bit becomes effective if the qualifying predicate (p2) and the gt Boolean result are both true.

| | | | |
|---|---|---|---|
| | eq | r1, 0 ! | // if (r1==0) return |
| (p2) | gt | r1, r2 ! | // if (p2) {if r2) return} |

If a compare instruction does not target p0 then its stop bit does not depend on the Boolean result. For example, the following lt instruction computes and writes it Boolean result to p2. The stop bit that specifies the return operation is unconditional, regardless of the Boolean result.

lt p2=r1, r2!//p2=(r1<r2); return

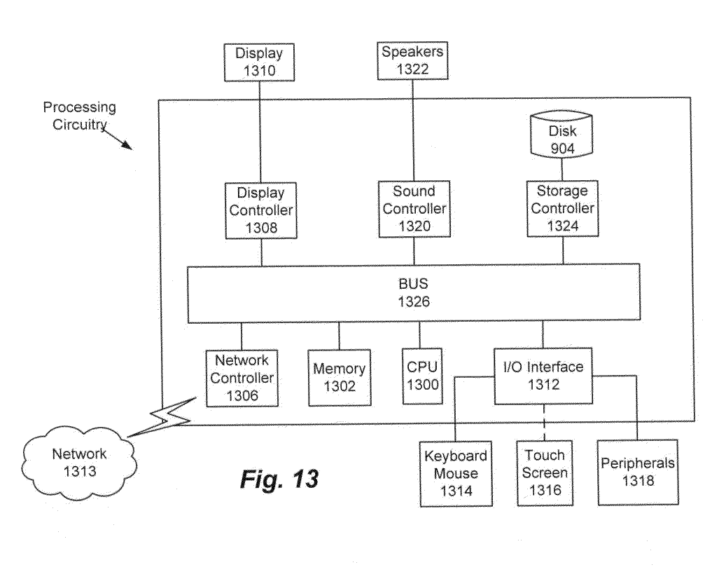

Next, a hardware description of the processing circuitry according to exemplary embodiments is described with reference to FIG. 13. In FIG. 13, the processing circuitry includes a CPU 1300 which performs the processes described above. The process data and instructions may be stored in memory 1302. These processes and instructions may also be stored on a storage medium disk 1304 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the processing circuitry communicates, such as a server or computer.

Further, the claimed advancements may be provided as a utility application, background daemon, or component of an operating system, or combination thereof, executing in conjunction with CPU 1300 and an operating system such as Microsoft Windows 7, UNIX, Solaris, LINUX, Apple MAC-OS and other systems known to those skilled in the art.

CPU 1300 may be a Xenon or Core processor from Intel of America or an Opteron processor from AMD of America, or may be other processor types that would be recognized by one of ordinary skill in the art. Alternatively, the CPU 1300 may be implemented on an FPGA, ASIC, PLD or using discrete logic circuits, as one of ordinary skill in the art would recognize. Further, CPU 1300 may be implemented as multiple processors cooperatively working in parallel to perform the instructions of the inventive processes described above.

The processing circuitry in FIG. 13 also includes a network controller 1306, such as an Intel Ethernet PRO network interface card from Intel Corporation of America, for interfacing with network 1313. As can be appreciated, the network 1313 can be a public network, such as the Internet, or a private network such as an LAN or WAN network, or any combination thereof and can also include PSTN or ISDN sub-networks. The network 1313 can also be wired, such as an Ethernet network, or can be wireless such as a cellular network including EDGE, 3G and 4G wireless cellular systems. The wireless network can also be WiFi, Bluetooth, or any other wireless form of communication that is known.

The processing circuitry further includes a display controller 1308, such as a NVIDIA GeForce GTX or Quadro graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard.

A sound controller 1320 is also provided in the processing circuitry, such as Sound Blaster X-Fi Titanium from Creative, to interface with speakers/microphone 1322 thereby providing sounds and/or music.

The general purpose storage controller 1324 connects the storage medium disk 904 with communication bus 1326, which may be an ISA, EISA, VESA, PCI, or similar, for interconnecting all of the components of the processing circuitry. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

1. A microprocessor comprising:
a decode configured to decode instructions of an instruction set architecture;
a fetch control unit configured to fetch instructions from a memory;
an instruction cache configured to store a plurality of fixed byte-length instructions;
a data cache configured to store data;
a control stack implemented with high speed control registers and a backing store allocated memory by a system software, and configured as a side effect of control and the stop bits to isolate control stack entries and addresses from direct manipulation from a user program; and
an instruction set, including:
a stop bit configured to indicate a function return, an indirect function call, or a loop branch, and pop a top address off the control stack and transfer the control back to a caller function, to an indirect function, or to a top of a loop block;
a qualifying predicate configured to allow a compare instruction to target an arbitrary number of predicates; and
an opcode configured to specify an operation to be performed.

2. The microprocessor of claim 1, wherein the stop bit eliminates return instructions and conditional branch instructions at an end of a loop block.

3. The microprocessor of claim 1, wherein the qualifying predicate allows a compare instruction to target an arbitrary number of predicates and reduces the conditional branch instructions.

4. The microprocessor of claim 1, wherein the stop bit marked in a conditional compare and return instruction discards a boolean result and triggers a return operation when the qualifying predicate and the boolean result are both true.

5. The microprocessor of claim 1, wherein the control stack replaces return instructions with the stop bit when performing loop iterates, function returns and indirect function calls.

6. The microprocessor of claim 1, wherein the instruction set includes a register and an immediate operand.

7. The microprocessor of claim 1, wherein the instruction set includes a register.

8. The microprocessor of claim 1, wherein the instruction set includes an immediate operand.

9. A data processing method, comprising:
fetching, with processing circuitry, instructions encoded with a stop bit from an instruction set architecture of the microprocessor;
popping, with processing circuitry, a top address off a control stack and transfer control back to a caller function, to an indirect function, or to a top of a loop block when the stop bit indicate a function return, an indirect function call, or a loop branch;
saving, with processing circuitry, control stack registers on a backing store after the stop bit indicate the function return, the indirect function call, or the loop branch when a number of used control stack registers exceeds a HI threshold;
overflowing, with processing circuitry, a control stack signal when the number of the used and the saved entries exceeds the backing store size;
allocating, with processing circuitry, more memory to increase a size of the backing store from a data cache or terminating the execution;
restoring, with processing circuitry, the control stack registers from the data cache when the number of the used control stack registers drops below a LO threshold.

10. The data processing method of claim 9, wherein the control stack implemented with high speed control registers and a backing store allocated memory by a system software, and configured as a side effect of control and the stop bits to isolate control stack entries and addresses from direct manipulation from a user program.

11. The data processing method of claim 9, wherein the stop bit eliminates return instructions and conditional branch instructions at an end of a loop block.

12. The data processing system of claim 9, wherein the qualifying predicate allows a compare instruction to target an arbitrary number of predicates and reduces the conditional branch instructions.

13. The data processing method of claim 9, wherein the stop bit marked in a conditional compare & return instruction discards a boolean result and triggers a return operation when the qualifying predicate and the boolean result are both true.

14. A non-transitory computer-readable medium storing executable instructions, which when executed by a computer processor, cause the computer processor to execute a method comprising:
fetching, with processing circuitry, instructions encoded with a stop bit from an instruction set architecture of the microprocessor;
popping, with processing circuitry, a top address off a control stack and transfer control back to a caller function, to an indirect function, or to a top of a loop block when the stop bit indicate a function return, an indirect function call, or a loop branch;
saving, with processing circuitry, control stack registers on a backing store after the stop bit indicate the function return, the indirect function call, or the loop branch when a number of used control stack registers exceeds a HI threshold;
overflowing, with processing circuitry, a control stack signal when the number of the used and the saved entries exceeds the backing store size;
allocating, with processing circuitry, more memory to increase a size of the backing store from a data cache or terminating the execution;
restoring, with processing circuitry, the control stack registers from the data cache when the number of the used control stack registers drops below a LO threshold.
